(19) United States
(12) Patent Application Publication
(10) Pub. No.: US 2008/0007418 A1
(43) Pub. Date: Jan. 10, 2008

(54) Proximity-triggered handrail cueing system with automatic attention capture

(76) Inventors: Brian Edward Maki, North York (CA); Philippe Corbeil, Neuville (CA); Carol Yvonne Scovil, Toronto (CA)

Correspondence Address: Ralph A. Dowell of DOWELL & DOWELL P.C., 2111 Eisenhower Ave, Suite 406, Alexandria, VA, 22314, US

(21) Appl. No.: 11/819,325

(22) Filed: Jun. 26, 2007

Related U.S. Application Data
(60) Provisional application No. 60/816,347, filed on Jun. 26, 2006.

(51) Int. Cl. G08B 5/00

(52) U.S. Cl. 340/686.6

(57) ABSTRACT

The present invention provides a proximity-triggered handrail cueing system with automatic attention capture for providing visual and auditory cues that automatically and involuntarily (subconsciously) attract attention to the handrail. The system includes a hand railing (i.e. handrail or grab bar) constructed from translucent or transparent plastic tubing, a series of lights mounted inside the railing, along the longitudinal axis, one or more auditory speakers built into the railing or railing brackets, and a proximity detector (e.g. photoelectric sensor) and controller that activates the lights and speakers whenever a person approaches the railing. The speakers can be used to issue a verbal prompt to hold the handrail. The lights inside the railing are triggered to suddenly start flashing in such a way as to automatically and subconsciously attract attention to the handrail, thereby facilitating ability to rapidly and effectively reach and grasp the handrail for support in the event that the person does not hold the railing voluntarily and subsequently experiences a sudden unexpected loss of balance. Sounds emitted by the speakers can also be used to improve the ability to rapidly grab the railing in response to loss of balance. Embodiments of the system may include: 1) a proximity-triggered handrail cueing system with automatic attention capture elicited by visual cueing, 2) a proximity-triggered handrail cueing system with automatic attention capture elicited by auditory cueing; and 3) a proximity-triggered handrail cueing system with automatic attention capture elicited by a combination of visual and auditory cueing.

### CROSS REFERENCE TO RELATED U.S. APPLICATIONS

This patent application relates to, and claims the priority benefit from, U.S. Provisional Patent Application Ser. No. 60/816,347 filed on Jun. 26, 2006, in English, entitled PROXIMITY-TRIGGERED HANDRAIL CUEING SYSTEM WITH AUTOMATIC ATTENTION CAPTURE, and which is incorporated herein by reference in its entirety.

### FIELD OF THE INVENTION

The present invention is related to a proximity-triggered handrail cueing system with automatic attention capture for providing visual and/or auditory cues that automatically and involuntarily attract attention to the handrail as the person approaches the handrail. More particularly, the features of the cueing are designed to cause the brain to subconsciously register the presence and location of the handrail, thereby facilitating ability to rapidly and effectively grasp the handrail for support should a sudden unexpected loss of balance occur.

### BACKGROUND OF THE INVENTION

Stair falls result in large numbers of serious injuries, as well as a substantial number of deaths, and are associated with very high health-care costs. The problem is not limited to older adults; however, older adults are definitely at higher risk of serious injury, despite the fact that they tend to use stairs less often than younger adults.

Although stair falls are complex multi-factorial events, there are two fundamental prerequisites for a fall to occur: there has to be an initial loss of balance due to a perturbation (e.g. slip, trip or misstep) and a failure to recover balance. Successful balance recovery on stairs is highly dependent on the ability to execute rapid reflex-like reactions in which a stabilizing hand-reaction force is generated by pushing or pulling on the stair handrail. If the stair user is already holding or touching the rail when the loss of balance occurs, then this reaction force can be generated very quickly, via reflex-like “hand-in-place” reactions. However, if the hand is not in contact with the rail, then a rapid reflex-like “reach-to-grasp” reaction must be executed first. If properly designed, handrails should help to reduce risk of stair falls and injuries by maximizing ability to rapidly reach and grasp the rail and to generate a stabilizing hand-reaction force in response to a sudden loss of balance; however, this requires that the person's brain is able to register the presence of the handrail and map its location in relation to the person's body prior to the sudden loss of balance. Older adults or persons with certain medical conditions may have visual or attention deficits that may impair the ability of the brain to register and map the location of the handrail. This, in turn, may impair ability to rapidly grasp the handrail for support if and when a sudden loss of balance occurs.

Previous inventions have described the design of lighting elements that can be incorporated into handrail systems; however, these lighting elements are designed specifically for purposes of improving illumination of the rail and/or surrounding environment in darkened rooms. In providing continuous rather than flashing illumination, such inventions will not be effective in automatically attracting attention to the rail. Furthermore, such systems may fail to attract attention to the rail because they are not triggered by a proximity sensor to provide an abrupt onset of cueing that would attract attention to the rail when it is most critical (i.e. during the interval when the person's brain would normally be expected to map the location of the handrail, approximately 1-2 seconds before the person arrives at the handrail). Furthermore, many previous inventions incorporate lighting or auditory elements that are not coincident with the spatial location of the handrail, and hence may not enhance (and may even impair) the ability of the brain to accurately map the location of the handrail. Other previous inventions have incorporated other cueing modalities (e.g. tactile or auditory) into handrail systems in order to provide specific information (e.g. to indicate the last step of a stairway), but such systems do not encourage the person to hold the handrail and will not facilitate ability to rapidly grasp the rail in response to a sudden loss of balance.

U.S. Pat. No. 5,626,094 describes a handrail with tactile cueing on the rail to indicate the last step of a stairway.

U.S. Pat. No. 6,752,772 describes a device which can be used to raise or lower a user into water for use in massage, water massage, physiotherapy or bathing and discloses using proximity activated or timed illumination of objects (including handrails) to guide the user towards a desired action when using the manipulator.

U.S. Pat. No. 5,450,299 describes an opaque handrail containing embedded lights (visible through cut-out sections of the opaque handrail), that are touch activated to provide illumination to the users as they traverse the area around the handrail.

U.S. Pat. No. 5,099,402 describes a solid handrail with accompanying lights that are included in the handrail assembly but housed separately from the handrail assembly and are intended to provide illumination to the user as they traverse the area around the handrail.

U.S. Pat. No. 6,752,521 describes a lighting solution for the interior of public transit vehicles: lights embedded in shoulder- or head-high rails which shine upwards, to reflect off the ceiling of the vehicle to provide ambient lighting for the purpose of providing lighting. The rails described in U.S. Pat. No. 6,752,521 are opaque with light-permeable apertures in the top surface of the rail.

U.S. Pat. No. 6,459,919 describes LED lights which can be positioned on the surface of a handrail.

U.S. Pat. No. 6,415,732 describes a lighted handrail (opaque casing with apertures to allow light through the rail) that can be used under water. The intent of this patent is to illuminate a handrail and to make it visible in a dark environment.

U.S. Pat. No. 5,396,740 describes a handrail containing photoluminescent inserts that are intended to increase the visibility of the handrail in poor lighting conditions.

U.S. Pat. No. 6,866,125 describes an illumination system for escalator handrails. This is intended to improve visibility of low contrast handrails, potentially in low light conditions.

U.S. Pat. No. 6,129,442 describes an illumination system for a conveyor, and is intended to increase lighting on the conveyor.

U.S. Pat. No. 6,848,805 (and the associated patents) describe an illumination system for a conveyor, and is intended to increase lighting on the conveyor.

Japanese Patent Application JP-A 05 193886 discloses a balustrade for an escalator or a moving walkway. The balustrade cooperates via a fitted-on receiving element with a handrail guide as well as with a illumination device provided next to the balustrade.

German Patent Application DE-A 199 57 680 discloses an illumination device for pedestrian conveyor systems, comprising at least one continuous light band, which extends in an operational state essentially over the length of the pedestrian conveyor system, and which is formed by contiguous luminous diodes. The same is provided inside a channel in the base and/or handrail area.

U.S. Pat. No. 6,676,278 describes LED lights which are positioned on the surface of a handrail.

U.S. Pat. No. 6,074,074 describes LED lights which are positioned on the surface of a handrail.

U.S. Pat. No. 6,030,108 describes a waterproof lighting tube that potentially can be used as a handrail. The intent of using this invention as a handrail is to illuminate the area around it and the lights in U.S. Pat. No. 6,030,108 do not have any proximity trigger.

United States Patent Publication 20050141225 describes a lighting bar which can be incorporated into a handrail.

U.S. Pat. No. 6,267,598 describes a touch activated sign which will play a recorded audio message.

U.S. Pat. No. 5,417,574 describes a message system on handrails, including both Braille and touch activated audio messages which primarily conveys information and directions.

Therefore, there is a need for a proximity-triggered handrail cueing system for providing visual and/or auditory cues that automatically and involuntarily attract attention to the handrail as the person approaches the handrail, for purposes of preventing the person from falling, either by: 1) encouraging the person to hold the handrail immediately, or by 2) improving the person's ability to rapidly and effectively grab the handrail for support in the event that the person fails to hold the handrail initially and subsequently experiences a sudden loss of balance (e.g. due to a slip, trip or misstep).

### SUMMARY OF INVENTION

As described in more detail below, the inventors have determined that the ability to rapidly and effectively grasp a handrail for support can be enhanced by using visual cueing to automatically and subconsciously attract attention to the rail, i.e. by using a proximity sensor to trigger lights that are coincident with the longitudinal axis of the handrail to suddenly begin flashing shortly before the person arrives at the handrail. In addition, the inventors have determined that a conscious decision to hold the handrail while traversing a stair or other passageway can be encouraged by using said proximity sensor to trigger a verbal prompt (e.g. “attention, use the handrail”) delivered by speakers located in close proximity to the handrail,

The present invention provides a proximity-triggered handrail cueing system with automatic attention capture for providing visual and auditory cues that automatically and involuntarily attract attention to the handrail as the person approaches the handrail. An embodiment of the invention includes a hand railing (i.e. handrail or grab bar) constructed from translucent or transparent plastic tubing, a series of lights mounted inside the railing along the longitudinal axis, one or more auditory speakers built into the railing or railing brackets, and a proximity detector (e.g. photoelectric sensor) that activates the lights and/or speakers whenever a person approaches the railing.

The auditory prompt (e.g. “attention, use the handrail”) is designed primarily to encourage the person to hold the railing, so as to prevent loss of balance, whereas the cueing provided by the lights inside the railing is designed primarily to improve the effectiveness of the reflex-like grabbing movements that are initiated automatically by the person's central nervous system in reaction to sudden loss of balance. These lights are triggered to suddenly begin to flash (e.g. at a frequency of approximately 3 Hz) preferably about 1-2 seconds before the person arrives at the handrail, thereby automatically and subconsciously attracting attention to the handrail, so that the person's brain registers and maps the presence and location of the handrail in relation to the person's body. This then facilitates ability to rapidly grab the railing for support, in the event that the person fails to hold the railing initially and subsequently does experience a sudden loss of balance (e.g. due to a slip, trip or misstep).

Whereas the verbal prompt is used to primarily influence voluntary behavior, the flashing lights are used primarily to influence involuntary motor behavior, i.e. the reflex-like grabbing movements that are initiated automatically by the central nervous system in reaction to loss of balance. The improved ability to recover balance by rapidly grabbing the rail occurs because the sudden onset of the flashing of the lights automatically and involuntarily attracts attention to the railing for a brief interval of time, thereby causing the brain to subconsciously register the presence of the railing and map its location in relation to the person's body.

Thus, an embodiment of present invention provides a proximity-triggered handrail cueing system with automatic attention capture elicited by visual cueing, comprising:
a hollow hand railing having a longitudinal axis constructed from translucent or transparent tubing;
a series of lights mounted inside the hollow railing, along the longitudinal axis;
a proximity detector;
a controller connected to said proximity detector and said series of lights, said controller being configured to activate said series of lights whenever said proximity detector detects a person approaching the hand railing;
said controller and said series of lights configured so that said series of lights flash in such a way as to automatically attract attention to the railing and thereby influence subsequent voluntary motor behavior by reminding and encouraging the person to hold the railing before any loss of balance can occur; and
said controller and said series of lights configured so that said series of lights flash in such a way as to automatically attract attention to the railing and thereby improve the effectiveness of subsequent involuntary motor behaviour including reflex-like grabbing movements that are initiated automatically by the person's central nervous system in reaction to a sudden unexpected loss of balance, in the event that the person does not hold the handrail voluntarily so as to prevent such loss of balance from occurring.

Another embodiment of the present invention includes a proximity-triggered handrail cueing system with automatic attention capture elicited by auditory cueing, comprising:
a hand railing;
one or more auditory speakers built into said hand railing or railing brackets used to mount said hand railing to a wall;
a proximity detector;
a controller connected to said proximity detector and said one or more auditory speakers, said controller and said one or more auditory speakers being configured to deliver a verbal prompt or other sounds whenever said proximity detector detects a person approaching the hand railing;
said verbal prompt or other sounds delivered in such a way as to automatically attract attention to the railing and thereby influence subsequent voluntary motor behavior by reminding and encouraging the person to hold the railing before any loss of balance can occur; and
said verbal prompt or other sounds being delivered in such a way as to automatically attract attention to the railing and thereby improve the effectiveness of subsequent involuntary motor behavior including reflex-like grabbing movements that are initiated automatically by the person's central nervous system in reaction to a sudden unexpected loss of balance, in the event that the person does not hold the handrail voluntarily so as to prevent such loss of balance from occurring.

Another embodiment of the present invention includes a proximity-triggered handrail cueing system with automatic attention capture elicited by a combination of visual and auditory cueing, comprising:
a hollow hand railing having a longitudinal axis constructed from translucent or transparent tubing;
a series of lights mounted inside the hollow railing, along the longitudinal axis;
one or more auditory speakers built into said hand railing or railing brackets used to mount said hollow hand railing to a wall;
a proximity detector;
a controller connected to said proximity detector, said series of lights and said one or more auditory speakers, said controller being configured to activate said series of lights and one or more auditory speakers whenever said proximity detector detects a person approaching the hand railing;
said controller and said one or more auditory speakers configured to deliver a verbal prompt or other sounds, alone or in combination with activation of said series of lights, in such a way as to automatically attract attention to the railing and thereby influence subsequent voluntary motor behavior by reminding and encouraging the person to hold the railing before any loss of balance can occur;
said controller and said series of lights configured so that said series of lights flash in such a way, alone or in combination with said verbal prompts or other sounds generated by said one or more auditory speakers, as to automatically attract attention to the railing and thereby improve the effectiveness of subsequent involuntary motor behaviour including reflex-like grabbing movements that are initiated automatically by the person's central nervous system in reaction to a sudden unexpected loss of balance, in the event that the person does not hold the handrail voluntarily so as to prevent such loss of balance from occurring.

A further understanding of the functional and advantageous aspects of the invention can be realized by reference to the following detailed description and drawings.

### BRIEF DESCRIPTION OF THE DRAWING

The invention will be more fully understood from the following detailed description thereof taken in connection with the accompanying drawing, which forms a part of this application, and in which:

FIG. 1 is a diagram showing one embodiment of the proximity-triggered handrail cueing system with automatic attention capture constructed in accordance with the present invention.

### DETAILED DESCRIPTION OF THE PREFERRED EMBODIMENT

The systems described herein are directed, in general, to embodiments of proximity-triggered handrail cueing system with automatic attention capture. Although embodiments of the present invention are disclosed herein, the disclosed embodiments are merely exemplary and it should be understood that the invention relates to many alternative forms, including different shapes and sizes. Furthermore, the Figures are not drawn to scale and some features may be exaggerated or minimized to show details of particular features while related elements may have been eliminated to prevent obscuring novel aspects. Therefore, specific structural and functional details disclosed herein are not to be interpreted as limiting but merely as a basis for the claims and as a representative basis for enabling someone skilled in the art to employ the present invention in a variety of manner. For purposes of instruction and not limitation, the illustrated embodiments are all directed to embodiments of proximity-triggered handrail cueing system with automatic attention capture.

As used herein, the term “about” or “approximately”, when used in conjunction with ranges or physical parameters such as for example sound level (decibels (db)), frequency, physical dimensions and the like, is meant to cover slight variations that may exist in the upper and lower limits of the ranges or parameters so as to not exclude embodiments with such parameters just outside this range. It is not the intention to exclude embodiments such as these from the present invention.

The inventors have discovered that the ability to rapidly and effectively grasp a handrail for support can be enhanced by using visual cueing (flashing lights) to automatically and subconsciously attract attention to the rail, and in an embodiment it is preferred that: 1) the lights are coincident with the longitudinal axis of the handrail; 2) the lights are triggered to begin flashing approximately 1-2 seconds before the person arrives at the handrail; 3) the lights flash at a frequency of approximately 3 Hz.

In addition, the inventors have discovered that a conscious decision to hold the handrail while traversing a stairway can be encouraged via a verbal prompt (e.g. “attention, use the handrail”), and in an embodiment of the system it is useful that: 1) the speakers delivering the verbal prompt are coincident with the location of the handrail; 2) the verbal prompt is triggered to begin approximately 1-2 seconds before the person arrives at the handrail; 3) the prompt comprises a short phrase (i.e. 4-6 words) that includes an initial signal word (e.g. “attention”); and 4) the prompt is delivered with an urgent tone (approximately 15 dB or more above ambient noise levels) by a female voice approximately two times before the person arrives at the handrail.

Embodiments of the proximity-triggered handrail cueing system with automatic attention capture include: 1) a proximity-triggered handrail cueing system with automatic attention capture elicited by visual cueing, 2) a proximity-triggered handrail cueing system with automatic attention capture elicited by auditory cueing; and 3) a proximity-triggered handrail cueing system with automatic attention capture elicited by a combination of visual and auditory cueing.

An embodiment of the proximity-triggered handrail cueing system with automatic attention capture elicited by a combination of visual and auditory cueing comprises a hollow transparent or translucent railing (i.e. handrail or grab bar), with a series of lights mounted along the inside of the railing and one or more audio speakers mounted in the rail assembly. The lights in the rail and a sound cue (such as a verbal prompt to “use the handrail”) are activated by a proximity detector when a person approaches the rail. The series of lights within the rail may be activated all at once, or in sequence along the rail, and can stay on, or flash until deactivated. The light and sound cues are deactivated automatically, either after a set period of time, or using a second proximity detector. The dual light and sound cues will draw attention to the railing, increasing safety by providing two lines of defence against falling. (1) The auditory prompt and flashing lights encourage the person to hold the railing, so as to prevent loss of balance. (2) Even if the person does not choose to use the handrail initially, the flashing lights will automatically attract the person's attention to the railing, facilitating the person's ability to rapidly grab the railing for support in the event that the person experiences a sudden loss of balance (e.g. due to a slip, trip or misstep).

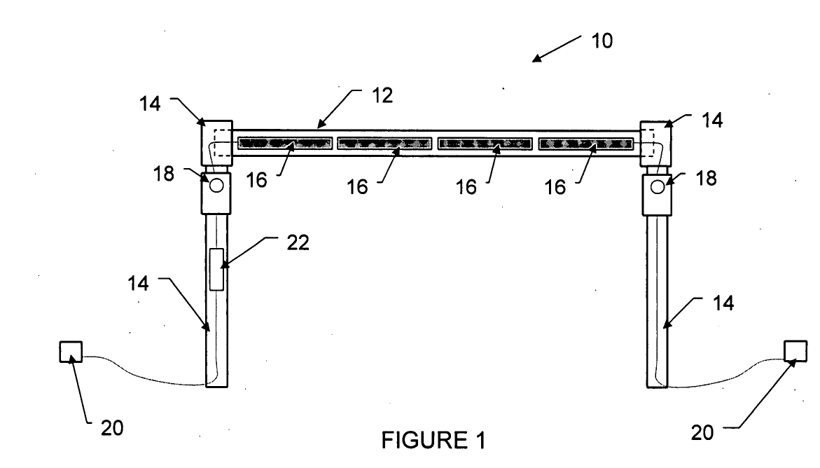

More particularly, referring to FIG. 1 a proximity-triggered handrail cueing system with automatic attention capture is shown generally at 10 in FIG. 1. The proximity-triggered handrail includes a hollow hand railing 12 (i.e. handrail or grab bar) constructed from translucent or transparent plastic tubing mounted on a wall or floor by railing brackets or posts 14, a series of lights 16 mounted inside the tubular railing 12 extending along the longitudinal axis of the tubing, one or more auditory speakers 18 built into the railing 12 or railing brackets or posts 14, and a proximity detector 20 that activates the lights 16 and speakers 18 whenever a person approaches the railing 10. The speakers 18 may be integrated with the controller unit 22, and are also connected to the proximity detectors 20, and the series of lights 16, as shown in FIG. 1.

The controller 22 is configured to activate the series of lights 16 and one or more auditory speakers 18 whenever the proximity detector 20 detects a person approaching the hand railing 12. The controller 22 and the auditory speakers 18 are configured to deliver a verbal prompt or other sounds, in such a way as to remind and encourage the person to hold the railing before any loss of balance can occur. The controller 22 and the series of lights 16 are configured to flash in such a way as to improve effectiveness of involuntary motor behaviour including reflex-like grabbing movements that are initiated automatically by the person's central nervous system in reaction to loss of balance, in the event that the person does not hold the handrail voluntarily so as to prevent such loss of balance from occurring. The proximity detector 20 and controller 22 can also be configured to deactivate the lights 16 after the person departs from the vicinity of the hand railing 12. Alternatively, the controller 22 may deactivate the lights after a pre-set period of time.

In one preferred embodiment, the lights comprise light-emitting diodes that are green in color, have an intensity of approximately 5000 millicandelas and have a viewing angle of approximately 90 degrees, and the auditory cue has a sound level that is about 15 dB or more greater than the ambient noise. The auditory cue can be an abstract tone or beeping sound; however, in one preferred embodiment, the auditory cue is a verbal phrase (approximately 4 to 6 words in length, with the first word being a signal word, e.g. “attention, use the handrail”) spoken in an urgent tone by a female voice and repeated twice before the person arrives at the handrail.

As mentioned above, railing 12 is preferably a transparent (or translucent) hollow tube for embodiments of the invention that provide visual cueing. Other than this specification, the railing must conform to building codes, which define limits for parameters such as strength, height and distance from the wall. To ensure adequate strength to support a person leaning or falling against the railing, handrail 12 in a preferred embodiment may be made from polycarbonate tubing, which can be manufactured transparent or translucent. Preferred dimensions for a hand rail 12 include using a tube with 1.75″ outer diameter (this size allows users to have strong grip on the rail), and a 1.25″ inner diameter, mounted 3′ above the floor or stair treads. In one preferred embodiment, the transluscent tubing is black in color, so as to increase contrast with respect to the internal lights, to enhance visibility and object recognition. The lights 16 may comprise a lighting unit small enough to fit inside the handrail 12. The lights 16 can be installed modularly, so that they can be controlled individually, to allow various flashing patterns on the rail.

In one embodiment, four lighting groups (0.4 m strips of 50 white light-emitting diodes) are used which can be independently controlled. In one preferred embodiment, all lighting elements are controlled to flash on and off simultaneously, at a frequency of approximately 3 Hz. This frequency enhances attention capture while minimizing danger to persons who may be at risk of photic-induced seizures (e.g. due to epilepsy).

The handrail mounts or posts 14 allow the handrail 12 to be mounted to a support surface. In FIG. 1, the handrail 12 is attached to vertical posts 14 attached to the ground. Alternatively, the handrail mounts 14 could be attached to a wall bracket.

Integrated controller 22 and speakers 18 may be incorporated into the handrail support mounts 14 (as in FIG. 1), the wall mounts of the handrail or into the handrail 12 itself, depending on the desired configuration. The speaker(s) 18 will project the verbal prompt and/or other auditory cues that may be desired. The control box 22 will contain the electronics including a microprocessor required to control the proximity detectors 20, lights 16 (visual cue), and the speaker or speakers 18 used to delivery the verbal prompt or other auditory cues. The controller 22 is not required to be integrated with speakers 18 and may be a separate unit housed in the railing 12 or mounts 14.

The proximity detector(s) 20 detect when a person is nearing the handrail from either direction, prompting the activation of the light and sound cues. The opposite proximity detector 20 can used to detect when the person has moved away from the handrail, to control the deactivation of the light and sound cues, if required.

In one configuration of the system, the proximity detector 20 includes a photoelectric sensor placed 1.5 m before the handrail, and 0.5 m from the ground. Other potential proximity detectors that could be used with the handrail include: a pressure mat on the floor or a video based motion detector, thermal or heat detectors and motion sensors.

Embodiments of the proximity-triggered handrail cueing system disclosed herein are designed to provide two lines of defence against falling: 1) a verbal prompt (e.g. “attention, use the handrail”) encourages the person to hold the railing 12, so as to prevent loss of balance; and 2) flashing of the lights 16 inside the railing 12 facilitates ability to rapidly and effectively grab the railing 12 for support, in the event that the person fails to hold the railing 12 initially and subsequently does experience a sudden loss of balance (e.g. due to a slip, trip or misstep).

Whereas the verbal prompt is intended to primarily influence volitional behavior, the flashing lights 16 are intended to primarily influence involuntary motor behavior, i.e. the reflex-like grabbing movements that are initiated automatically by the central nervous system in reaction to loss of balance. The improved ability to recover balance by rapidly grabbing the rail occurs because the flashing of the lights automatically and involuntarily attracts attention to the railing 12 for a brief interval of time, thereby causing the person's brain to register the presence of the railing 12 and its location in relation to the person's body. The brain can then use this information to very rapidly guide the hand toward the rail, if and when sudden loss of balance occurs.

The flashing of the lights 16 may also improve the effectiveness of the verbal prompt, by directing visual attention to the railing during the verbal prompt. The flashing is controlled to stop after a pre-determined period of time, or when a second proximity sensor detects that the person is no longer near the railing. In one preferred embodiment of the invention, the lights flash at a frequency of approximately 3 Hz and the system is configured so that they begin flashing at a preferred frequency of about 3 Hz about 1 to 2 seconds before the person arrives at the hand railing, and wherein said sounds produced by the auditory speakers have an intensity of about 15 dB or more above ambient noise levels.

System 10 can be configured to allow the verbal prompt to be disabled, e.g. in situations where the prompt may be disruptive, distracting or annoying.

Previous railing designs that have incorporated lighting elements have been designed to provide continuous illumination, once activated, with the sole purpose of improving ability to see the railing and/or stairs and surrounding environment. One novel aspect of the present invention lies in the fact that the lights are triggered by a proximity sensor to suddenly begin to flash on and off in such a way as to automatically and involuntarily attract attention to the rail 12 as the person approaches the handrail.

A second novel aspect lies in the two-pronged approach to preventing falls, i.e. the combination of a verbal prompt that requires volitional action with a visual cueing system that automatically and involuntarily attracts attention to the railing 12 and hence provides protection in the event that the verbal prompt is disregarded or misunderstood. Previous designs have used verbal prompts to provide warning about safety hazards (e.g. when persons near the end of a “moving sidewalk”) but have not been used to encourage handrail use, nor have they been used in conjunction with a visual attention-grabbing system in the manner described above.

The inventors have performed novel experiments (described in detail below) that have demonstrated that the invention is effective in: 1) causing more persons to hold the handrail 12 voluntarily (prior to experiencing any loss of balance), and 2) improving the ability to reflexively reach and grasp the handrail 12 in response to a subsequent, sudden unexpected loss of balance, in the event that the person fails to hold the handrail voluntarily.

Embodiments of the proximity-triggered handrail cueing system with automatic attention capture elicited by visual cueing alone as mentioned above would be similar to the system shown in FIG. 1 but would not have the speakers present.

Embodiments of the proximity-triggered handrail cueing system with automatic attention capture elicited by auditory cueing alone would not require a hollow transparent or translucent railing.

The utility of the invention lies in its ability to attract attention to the railing and thereby reduce risk of falling without necessarily requiring any voluntary intent, effort or compliance on the part of the individual. Thus, for example, the system can be used to reduce risk of falling in persons who may fail to respond to verbal prompts (e.g. instructions to “use the rail”) due to distractions, cognitive impairments and/or inability to understand the language in which the prompt is delivered.

The system disclosed herein may be installed within building environments (residential, commercial or public) or in exterior locations, wherever conventional handrails or grab bars are used to reduce risk of falling. This includes, but is not limited to: 1) stairways, steps, curbs, ramps and sidewalks; 2) hallways, aisles and lobbies; 3) bedrooms and bathrooms; and 4) vehicles such as buses, trains, subway cars and ships. The invention is of great benefit in reducing risk of falls and related injuries in settings where a high percentage of the people have impaired balance control (e.g. nursing homes, hospitals). However, the benefits are not limited to persons with impaired balance, since many healthy children, young adults and middle-aged adults experience serious or even fatal falls on stairs or in other hazardous environments (e.g. workplace settings where slippery floors are prevalent). Such individuals may be more likely than older or less healthy persons to neglect to hold onto the railing while traversing a stairway or slippery area; hence, the capacity of the invention to automatically enhance ability to grab the railing (in response to a slip, trip or misstep) will be of paramount importance in preventing a fall in these individuals.

The following section describes the findings of novel experiments performed by the inventors to determine the effectiveness of the present invention in attracting attention to the handrail 12 and thereby improving the ability of persons to respond to sudden unexpected loss of balance and prevent themselves from falling by grasping the handrail. These experiments have provided evidence to support the effectiveness of the invention and have led to the specifications for the preferred embodiments of the invention, which have not been disclosed in prior inventions and are not obvious from the prior art.

Experimental

Study #1:

The handrail cueing systems were evaluated using a large motion platform (2 m wide, 6 m long) configured to simulate a “real-life” environment, including a stair, handrail and various visual distracters (e.g. desk, computer, telephone, chair, house plant). The platform was triggered to move suddenly forward or backward so as to deliver a balance perturbation and thereby cause a loss of balance as the subject approached the handrail. To simulate the unexpected nature of the balance perturbations that typically lead to falls in daily life, the subjects were deceived into believing that the platform was not going to move; hence, the subsequent platform motion and balance perturbation was not expected by the subjects. To prevent learning and adaptation, each subject performed only one trial, which was his or her very first exposure to the perturbation and environment.

A door prevented the subjects from viewing the environment prior to the start of the trial. The subjects were given the task of making a telephone call, which required opening the door, performing a visual search for the phone and walking to the far end of the platform to access the phone. The platform was triggered to move forward or backward suddenly and unexpectedly when the subjects stepped on a pressure mat adjacent to the handrail, so as to evoke a reach-to-grasp reaction. The handrail cueing was triggered by a photocell when the subject was 1.4 m from the handrail, ensuring that the subjects were exposed to the cueing for approximately 2 s before arriving at the handrail.

Three cueing conditions were tested: 1) visual cue, 2) verbal cue, and 3) no cue. The same hollow black translucent handrail was used in all trials. In the visual-cue trials, yellow light-emitting diodes (mounted internally along the longitudinal access of the handrail) were triggered by the aforementioned proximity sensor to suddenly begin flashing at a frequency of 3 Hz when the subject approached the handrail. In the verbal-cue trials, the proximity sensor caused speakers located near the handrail to issue a verbal prompt (“attention, use the handrail”) when the subject approached the handrail. Ten healthy, community-dwelling older adults aged 57-70 (4 male, 6 female) and eleven young adults aged 20-35 (7 male, 4 female) were each assigned to be tested using one of the three cueing conditions. In initial tests, ten subjects performed the “telephone task” described above without balance perturbation (i.e. the platform did not move). Following these tests, eleven new subjects were tested using various perturbation magnitudes and directions (maximum platform acceleration, velocity and displacement of 3.5 m/s², 1.0 m/s and 0.43 m, respectively; duration 0.6 s). Based on previous studies by the inventors, it was expected that the selected balance perturbations would be sufficiently large to evoke a reach-to-grasp balance-recovery reaction in the majority of subjects. In each trial, a video-based motion-analysis system was used to record arm movements, and a lightweight head-mounted eye tracker was used to record eye movements and gaze direction.

Results indicated that subjects were most likely to look at the handrail (when walking for the first time in the unfamiliar environment) when there was a verbal cue (67% of trials) or visual cue (50% of trials), in comparison to a conventional rail with no cueing (38% of trials). Furthermore, grasping of the rail occurred more often when there was a verbal cue (67% of trials) or visual cue (40% of trials), in comparison to a conventional rail with no cueing (10% of trials). These results thus indicate that the visual and/or verbal cueing did help to attract visual attention toward the handrail and thereby increased the tendency to grasp the handrail for support.

Study #2:

In a second study, twenty-three (23) healthy community-dwelling older adults aged 64-80 (6 male, 17 female) were tested using three cueing conditions: 1) visual cue, 2) combined visual-plus-verbal cue, and 3) no cue. The experimental setup, equipment and protocol were the same as in Study #1, with the following exceptions: 1) green (rather than yellow) light-emitting diodes were used; 2) the verbal cue (“attention, use the handrail”) was triggered in combination with a simultaneous visual cue (i.e. flashing of the green lights at 3 Hz); 3) all subjects were exposed to a sudden unexpected balance perturbation as they approached the handrail; and 4) the same perturbation was used for all subjects (forward platform motion; acceleration, velocity and displacement of 3.5 m/s², 1.1 m/s and 0.43 m, respectively; duration 0.6 s). As in Study #1, subjects were randomly assigned to one of the three cueing conditions, performed only a single trial (their very first exposure to the environment and perturbation) so as to prevent learning and adaptation, and did not expect that the platform would move.

Similar to Study #1, results indicated that the cueing attracted attention to the handrail. Subjects looked directly at the handrail (prior to the sudden unexpected loss of balance) in 71% of trials with visual-plus-verbal cueing and 33% of trials with visual cueing, compared to only 22% of no-cueing trials. Furthermore, the cueing improved ability to recover balance by grasping the handrail. Grasping errors (overshoot or collision of the hand with the rail) occurred in 44% of no-cue trials but in only 17% of visual-cue trials and only 14% of trials with visual-plus-verbal cueing. The average time required to grasp the rail (after perturbation onset) was reduced from 0.63 seconds in no-cue trials to 0.57 seconds with visual-plus-verbal cueing and 0.48 seconds with visual cueing. The combined visual-plus-verbal cueing had the additional benefit of causing some subjects (29%) to grasp the rail prior to the balance perturbation.

These results thus indicate that the invention will be effective in attracting attention to the handrail and will thereby reduce the risk of falling, either by: 1) causing the person to hold the handrail before there is any opportunity for loss of balance to occur; or 2) improving the ability to rapidly and effectively grasp the handrail for support in response to a sudden unexpected loss of balance.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. A proximity-triggered handrail cueing system with automatic attention capture elicited by visual cueing, comprising:
a hollow hand railing having a longitudinal axis constructed from translucent or transparent tubing;
a series of lights mounted inside the hollow railing, along the longitudinal axis;
a proximity detector;
a controller connected to said proximity detector and said series of lights, said controller being configured to activate said series of lights whenever said proximity detector detects a person approaching the hand railing;
said controller and said series of lights configured so that said series of lights flash in such a way as to automatically attract attention to the railing and thereby influence subsequent voluntary motor behavior by reminding and encouraging the person to hold the railing before any loss of balance can occur; and
said controller and said series of lights configured so that said series of lights flash in such a way as to automatically attract attention to the railing and thereby improve the effectiveness of subsequent involuntary motor behavior including reflex-like grabbing movements that are initiated automatically by the person's central nervous system in reaction to a sudden unexpected loss of balance, in the event that the person does not hold the handrail voluntarily so as to prevent such loss of balance from occurring.

2. The system according to claim 1 wherein said railing is translucent and black in color.

3. The system according to claim 1 wherein said series of lights emit light which is green in color and are triggered by said proximity sensor to suddenly begin flashing at a preferred frequency of about 3 Hz, about 1 to 2 seconds before the person arrives at the hand railing.

4. The system according to claim 3 wherein said railing is translucent and black in color.

5. The system according to claim 1 wherein said proximity detector is any one or combination of: a photoelectric sensor, a heat sensor, a motion sensor, a force sensor, a pressure sensor and a video based detection system.

6. The system according to claim 2 wherein said proximity detector is any one or combination of: a photoelectric sensor, a heat sensor, a motion sensor, a force sensor, a pressure sensor and a video based detection system.

7. The system according to claim 3 wherein said proximity detector is any one or combination of: a photoelectric sensor, a heat sensor, a motion sensor, a force sensor, a pressure sensor and a video based detection system.

8. The system according to claim 4 wherein said proximity detector is any one or combination of: a photoelectric sensor, a heat sensor, a motion sensor, a force sensor, a pressure sensor and a video based detection system.

9. A proximity-triggered handrail cueing system with automatic attention capture elicited by auditory cueing, comprising:
a hand railing;
one or more auditory speakers built into said hand railing or railing brackets used to mount said hand railing to a wall;
a proximity detector;
a controller connected to said proximity detector and said one or more auditory speakers, said controller and said one or more auditory speakers being configured to deliver a verbal prompt or other sounds whenever said proximity detector detects a person approaching the hand railing;
said verbal prompt or other sounds delivered in such a way as to automatically attract attention to the railing and thereby influence subsequent voluntary motor behavior by reminding and encouraging the person to hold the railing before any loss of balance can occur; and
said verbal prompt or other sounds being delivered in such a way as to automatically attract attention to the railing and thereby improve the effectiveness of subsequent involuntary motor behavior including reflex-like grabbing movements that are initiated automatically by the person's central nervous system in reaction to a sudden unexpected loss of balance, in the event that the person does not hold the handrail voluntarily so as to prevent such loss of balance from occurring.

10. The system according to claim 9 wherein said sounds produced by said auditory speakers have an intensity of about 15 dB or more above ambient noise levels, and wherein said sounds produced by said auditory speakers comprise a short verbal phrase that begins with a signal word and is about 4-6 words in length delivered in an urgent tone by a female voice, and triggered by said proximity sensor so as to be delivered about two times before the person arrives at the hand railing.

11. The system according to claim 9 wherein said proximity detector is any one or combination of: a photoelectric sensor, a heat sensor, a motion sensor, a force sensor, a pressure sensor and a video based detection system.

12. The system according to claim 1 0 wherein said proximity detector is any one or combination of: a photoelectric sensor, a heat sensor, a motion sensor, a force sensor, a pressure sensor and a video based detection system.

13. A proximity-triggered handrail cueing system with automatic attention capture elicited by a combination of visual and auditory cueing, comprising:
a hollow hand railing having a longitudinal axis constructed from translucent or transparent tubing;
a series of lights mounted inside the hollow railing, along the longitudinal axis;
one or more auditory speakers built into said hand railing or railing brackets used to mount said hollow hand railing to a wall;
a proximity detector;
a controller connected to said proximity detector, said series of lights and said one or more auditory speakers, said controller being configured to activate said series of lights and one or more auditory speakers whenever said proximity detector detects a person approaching the hand railing;
said controller and said one or more auditory speakers configured to deliver a verbal prompt or other sounds, alone or in combination with activation of said series of lights, in such a way as to automatically attract attention to the railing and thereby influence subsequent voluntary motor behavior by reminding and encouraging the person to hold the railing before any loss of balance can occur;
said controller and said series of lights configured so that said series of lights flash in such a way, alone or in combination with said verbal prompts or other sounds generated by said one or more auditory speakers, as to automatically attract attention to the railing and thereby improve the effectiveness of subsequent involuntary motor behaviour including reflex-like grabbing movements that are initiated automatically by the person's central nervous system in reaction to a sudden unexpected loss of balance, in the event that the person does not hold the handrail voluntarily so as to prevent such loss of balance from occurring.

14. The system according to claim 13 wherein said railing is translucent and black in color.

15. The system according to claim 13 wherein said series of lights emit light which is green in color and are triggered by said proximity sensor to suddenly begin flashing at a preferred frequency of about 3 Hz, about 1 to 2 seconds before the person arrives at the hand railing.

16. The system according to claim 15 wherein said railing is translucent and black in color.

17. The system according to claim 13 wherein said sounds produced by said auditory speakers have an intensity of about 15 dB or more above ambient noise levels, and wherein said sounds produced by said auditory speakers comprise a short verbal phrase that begins with a signal word and is about 4-6 words in length delivered in an urgent tone by a female voice, and triggered by said proximity sensor so as to be delivered about two times before the person arrives at the hand railing.

18. The system according to claim 17 wherein said railing is translucent and black in color.

19. The system according to claim 13 wherein said series of lights emit light which is green in color and are triggered by said proximity sensor to suddenly begin flashing at a preferred frequency of about 3 Hz, about 1 to 2 seconds before the person arrives at the hand railing, and wherein said sounds produced by said auditory speakers have an intensity of about 15 dB or more above ambient noise levels, and wherein said sounds produced by said auditory speakers comprise a short verbal phrase that begins with a signal word and is about 4-6 words in length delivered in an urgent tone by a female voice, and triggered by said proximity sensor so as to be delivered about two times before the person arrives at the hand railing.

20. The system according to claim 19 wherein said railing is translucent and black in color.

21. The system according to claim 13 wherein said proximity detector is any one or combination of: a photoelectric sensor, a heat sensor, a motion sensor, a force sensor, a pressure sensor and a video based detection system.

22. The system according to claim 15 wherein said proximity detector is any one or combination of: a photoelectric sensor, a heat sensor, a motion sensor, a force sensor, a pressure sensor and a video based detection system.

23. The system according to claim 16 wherein said proximity detector is any one or combination of: a photoelectric sensor, a heat sensor, a motion sensor, a force sensor, a pressure sensor and a video based detection system.

24. The system according to claim 17 wherein said proximity detector is any one or combination of: a photoelectric sensor, a heat sensor, a motion sensor, a force sensor, a pressure sensor and a video based detection system.

25. The system according to claim 19 wherein said proximity detector is any one or combination of: a photoelectric sensor, a heat sensor, a motion sensor, a force sensor, a pressure sensor and a video based detection system.
